(19) United States
(12) Patent Application Publication
(10) Pub. No.: US 2024/0375579 A1
(43) Pub. Date: Nov. 14, 2024

(54) INFORMATION NOTIFICATION DEVICE AND INFORMATION NOTIFICATION METHOD

(71) Applicant: TOYOTA JIDOSHA KABUSHIKI KAISHA, Toyota-shi Aichi-ken (JP)

(72) Inventors: Tomohiko Kaneko, Yokohama-shi kanagawa-ken (JP); Junichi Morimura, Sunto-gun Shizuoka-Ken (JP); Shun Maruyama, Numazu-shi Shizuoka-ken (JP); Ryoma Hiraike, Toyota-shi Aichi-ken (JP); Satoshi Omi, Ebina-shi Kanagawa-ken (JP)

(73) Assignee: TOYOTA JIDOSHA KABUSHIKI KAISHA, Toyota-shi Aichi-ken (JP)

(21) Appl. No.: 18/656,979

(22) Filed: May 7, 2024

(30) Foreign Application Priority Data
May 11, 2023 (JP) 2023-078723

(51) Int. Cl. B60Q 1/50

(52) U.S. Cl. CPC B60Q 1/535; B60Q 1/5037; B60Q 1/507; B60Q 2800/10

(57) ABSTRACT

An information notification device is provided with a notification control unit configured to notify a rear vehicle that a host vehicle is giving right of way to others via a first display provided in the host vehicle so as to be visually recognized from the rear vehicle in a stop state in which the host vehicle is stopped in order to give right of way to others.

### CROSS-REFERENCE TO RELATED APPLICATIONS

This application claims priority to Japanese Patent Application No. 2023-078723 filed May 11, 2023, the entire contents of which are herein incorporated by reference.

### FIELD

The present disclosure relates to an information notification device and an information notification method.

### BACKGROUND

JP2013-120574A discloses that, when a pedestrian hidden by a parked vehicle in front of a host vehicle is detected by communication between the pedestrian and the host vehicle, information about the pedestrian (an icon of the pedestrian and a time until the pedestrian is visually recognized) is displayed on a human machine interface of the host vehicle.

JP2017-174449A discloses that, in a case where there is a risk of collision between a pedestrian located in front of the host vehicle and a rear vehicle located behind the host vehicle, the danger of collision is notified to the pedestrian and the rear vehicle using a headlight, a horn, or the like) mounted on the host vehicle.

JP2019-026201A discloses that information is notified to a pedestrian in the vicinity of the host vehicle during autonomous driving.

### SUMMARY

If the host vehicle is an autonomous driving vehicle, the behavior of the host vehicle is controlled in accordance with situations around the host vehicle and the host vehicle may stop to grant right of way to others such as pedestrians. In such a case, there is a possibility that the rear vehicle located behind the autonomous vehicle cannot correctly grasp the intention of the autonomous vehicle.

In this regard, in the technique disclosed in JP2013-120574A or JP2019-026201A, it is not assumed that information is notified from the host vehicle to the rear vehicle. In addition, even if light or sound is emitted from the host vehicle as disclosed in JP2017-174449A, there is a possibility that the driver of the rear vehicle may feel anxious because the driver cannot grasp the intention of the host vehicle.

The present disclosure has been made focusing on such problems, and an object thereof is to accurately convey the intention of the host vehicle to the rear vehicle when the host vehicle is giving way to others.

The gist of the present disclosure is as follows:

(1) An information notification device configured to notify visual information to a rear vehicle located behind the host vehicle that automatically starts and stops, wherein the information notification device comprises a notification control unit configured to notify the rear vehicle that the host vehicle is giving right of way to others via a first display provided in the host vehicle so as to be visually recognized from the rear vehicle in a stop state in which the host vehicle is stopped in order to give right of way to the others.

(2) An information notification device according to the above (1), wherein the notification control unit is configured to notify the rear vehicle of time until the vehicle starts, via the first display, in the stop state.

(3) An information notification device according to the above (1) or the above (2), wherein the notification control unit is configured to notify the others of a warning via a second display provided in the host vehicle so as to be visually recognized from the front of the host vehicle when the passing of the host vehicle by the rear vehicle is detected in the stop state.

(4) An information notification device according to any one of the above (1) to the above (3), wherein the notification control unit is configured to notify the rear vehicle that the host vehicle is giving right of way to others by displaying an image generated by a front camera provided in the host vehicle on the first display in the stop state.

(5) An information notification method executed by a computer, wherein the information notification method includes notifying the rear vehicle that the host vehicle is giving right of way to others via a first display provided in the host vehicle so as to be visually recognized from the rear vehicle in a stop state in which the host vehicle is stopped in order to give right of way to others.

According to this aspect of the present disclosure, it is possible to accurately convey the intention of the host vehicle to the rear vehicle when the host vehicle is giving way to others.

### BRIEF DESCRIPTION OF DRAWINGS

FIG. 1 is a view schematically showing a part of a configuration of a vehicle provided with an information notification device according to an embodiment of the present disclosure.

FIG. 2 is a schematic view of a vehicle.

FIG. 3 is a functional block view of a processor of an electronic control unit.

FIG. 4 is a view showing an example of a situation in which a vehicle grants right of way to others.

FIG. 5 is a flowchart showing the control routine of the notification process according to the present embodiment.

FIG. 6 is a view showing an example of information displayed on a first display for a rear vehicle.

### DESCRIPTION OF EMBODIMENTS

Below, referring to the drawings, an embodiment of the present disclosure will be explained in detail. Note that, in the following explanation, similar component elements will be assigned the same reference notations.

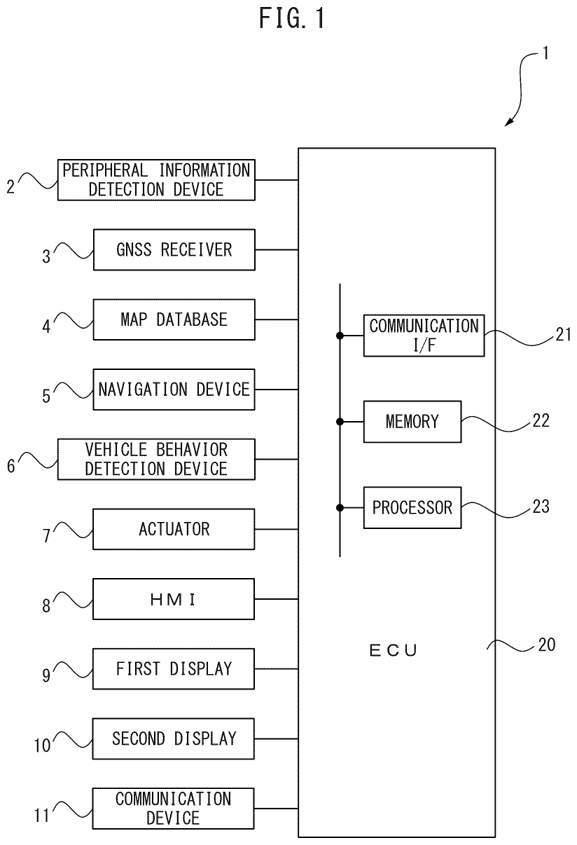

FIG. 1 a view schematically showing a part of a configuration of a vehicle 1 provided with an information notification device according to an embodiment of the present disclosure.

As shown in FIG. 1, the vehicle 1 is provided with a peripheral information detection device 2, a GNSS (Global Navigation Satellite System) receiver 3, a map database 4, a navigation device 5, a vehicle behavior detection device 6, an actuator 7, a human machine interface (HMI) 8, a first display 9, a second display 10, a communication device 11, and an electronic control unit (ECU) 20. The peripheral information detection device 2, GNSS receiver 3, the map database 4, the navigation device 5, the vehicle behavior detection device 6, the actuator 7, HMI 8, the first display 9, the second display 10, and the communication device 11 are electrically connected to ECU 20 via an in-vehicle network or the like compliant with standards such as CAN (Controller Area Network).

The peripheral information detection device 2 acquires data (images, point cloud data, and the like) around the vehicle 1 (the host vehicle), and detects peripheral information of the vehicle 1 (for example, a peripheral vehicle, a pedestrian, a two-wheeled vehicle, a lane, a falling object, an animal, a construction site, and the like). For example, the peripheral information detection device 2 includes a millimeter-wave radar, a camera (monocular camera or stereo camera), a LIDAR (Laser Imaging Detection And Ranging), or an ultrasonic sensor (sonar), or any combination thereof. Outputs of the peripheral information detection device 2, that is, the peripheral information of the vehicle 1 detected by the peripheral information detection device 2 is transmitted to ECU 20.

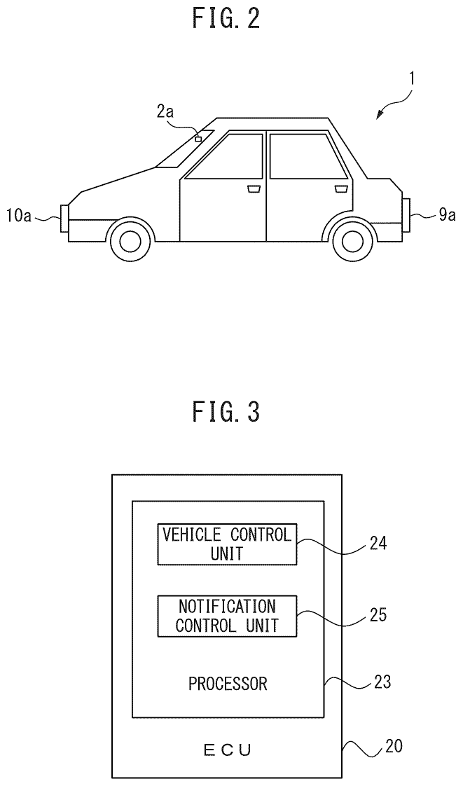

FIG. 2 is a schematic view of a vehicle 1. As shown in FIG. 2, the vehicle 1 is provided with a front-camera 2a. The front camera 2a is arranged at a front portion of the vehicle 1 (for example, a rear surface of a rear-view mirror in the vehicle 1, a front bumper, or the like) so as to capture an image of the front of the vehicle 1. The front camera 2a captures an image of the front of the vehicle 1 and generates an image of the front of the vehicle 1. The front camera 2a is an example of the peripheral information detection device 2.

GNSS receiver 3 detects the present position of the vehicle 1 (for example, the latitude and longitude of the vehicle 1) based on positioning information obtained from a plurality of (for example, three or more) positioning satellites. Specifically, GNSS receiver 3 captures a plurality of positioning satellites and receives radio waves transmitted from the positioning satellites. Then, GNSS receiver 3 calculates the distance to the positioning satellite based on the difference between the transmission time and the reception time of the radio wave, and detects the present position of the vehicle 1 based on the distance to the positioning satellite and the position (orbit information) of the positioning satellite. The output of GNSS receiver 3, i.e. the present position of the vehicles 1 detected by GNSS receiver 3, is transmitted to ECU 20. GNSS receiver 3 includes a GPS receiver.

The map database 4 stores map information. ECU 20 acquires map data from the map data base 4. Note that the map database 4 may be provided outside the vehicle 1 (e.g., servers, and the like), and ECU 20 may acquire map information from outside the vehicle 1.

The navigation device 5 sets a travel route of the vehicle 1 to a destination based on the present position of the vehicle 1 detected by GNSS receiver 3, map information of the map database 4, input by the occupant (for example, a driver) of the vehicle 1, and the like. The travel route set by the navigation device 5 is transmitted to ECU 20.

The vehicle behavior detection device 6 detects a parameter indicating the behavior of the vehicle 1. The vehicle behavior detection device 6 includes, for example, a vehicle speed sensor that detects the speed of the vehicle 1, a yaw rate sensor that detects the yaw rate of the vehicle 1, and the like. The output of the vehicle behavior detection device 6, i.e., the parameter detected by the vehicle behavior detection device 6, is transmitted to ECU 20.

The actuator 7 operates the vehicle 1. For example, the actuator 7 includes a drive unit (for example, at least one of an internal combustion engine and an electric motor) for acceleration of the vehicle 1, a brake actuator for braking (decelerating) of the vehicle 1, a steering actuator for steering of the vehicle 1, and the like. ECU 20 controls the actuator 7 to control the behavior of the vehicle 1.

HMI 8 is provided in the interior of the vehicle 1 and exchanges data between the vehicle 1 and an occupant (for example, a driver) of the vehicle 1. HMI 8 includes an output unit (for example, a display, a speaker, a light source, a vibrating unit, and the like) that provides information to an occupant of the vehicle 1, and an input unit (for example, a touch panel, an operation button, an operation switch, a microphone, and the like) to which information is input by the occupant of the vehicle 1. The output of ECU 20 is notified to the occupant of the vehicle 1 via HMI 8, and the input from the occupant of the vehicle 1 is transmitted to ECU 20 via HMI 8. HMI 8 may be an input device, an output device, or an input/output device. Note that a mobile terminal (a smart phone, a tablet terminal, or the like) of the occupant of the vehicle 1 may be connected to ECU20 so as to be able to communicate by wire or wirelessly, and may function as HMI 8. HMI 8 may be integrated with the navigation device 5.

The first display 9 is provided in the vehicle 1 so as to be visually recognized by a rear vehicle located behind the vehicle 1. The rear vehicle includes not only a vehicle located behind the vehicle 1 in the same lane as the vehicle 1, but also a two-wheeled vehicle (a motorcycle or a bicycle) located on the side of the vehicle 1 and behind the front portion of the vehicle 1. The output of ECU 20 is notified to the rear vehicle via the first display 9. As shown in FIG. 2, the vehicle 1 is provided with a rear display 9a. The rear display 9a is arranged at the rear of the vehicle 1 (e.g. above the license plate and between the tail lamps) and displays the data towards the rear of the vehicle 1. The rear display 9a is an example of the first display 9. The first display 9 may be provided on a side portion or a top portion of the vehicle 1. Further, the first display 9 may be provided in the interior of the vehicle 1 as long as it can be visually recognized from the rear vehicle.

The second display 10 is provided in the vehicle 1 so as to be visually recognized from the front of the vehicle 1. The output of ECU 20 is notified to the front of the vehicle 1 via the second display 10. As shown in FIG. 2, the vehicle 1 is provided with a front display 10a. The front display 10a is arranged at a front portion of the vehicle 1 (e.g., above the license plate and between the headlights), and displays data toward the front of the vehicle 1. The front display 10a is an example of the second display 10. The second display 10 may be provided on the side portion or the top portion of the vehicle 1. Further, the second display 10 may be provided in the interior of the vehicle 1 as long as it can be visually recognized from the front of the vehicle 1.

The communication device 11 is capable of communicating with the outside of the vehicle 1, and is capable of communicating between the vehicle 1 and the outside of the vehicle 1. For example, the communication device 11 includes a wide area communication device that enables wide area communication between the vehicle 1 and the outside of the vehicle 1 (for example, a server) via a communication network such as a carrier network or an internet network, and an inter-vehicle communication device that enables inter-vehicle communication between the vehicle 1 and the surrounding vehicles using a predetermined frequency band.

ECU 20 executes various controls of the vehicles 1. As shown in FIG. 1, ECU 20 includes a communication interface 21, a memory 22, and a processor 23. The communication interface 21 and the memory 22 are connected to the processor 23 via signal lines. In the present embodiment, one ECU 20 is provided, but a plurality of ECU's may be provided for each function.

The communication interface 21 has interface circuitry for connecting ECU 20 to the in-vehicle networking. ECU 20 is connected to other in-vehicle devices via the communication interface 21.

The memory 22 includes, for example, a volatile semiconductor memory and a non-volatile semiconductor memory. The memory 22 stores programs, data, and the like used when various kinds of processing are executed by the processor 23.

The processor 23 includes one or more CPU's (Central Processing Unit) and its peripheral circuitry. The processor 23 may further include an arithmetic circuit such as a logical arithmetic unit or a numerical arithmetic unit.

In the present embodiment, the vehicle 1 is an autonomous vehicle that automatically starts and stops the vehicle 1. For example, when the vehicle 1 is capable of performing autonomous driving at level 1 or level 2, the vehicle 1 is automatically started and stopped while the driver of the vehicle 1 is obliged to monitor the surroundings. On the other hand, in a case where the vehicle 1 is capable of performing autonomous driving at level 3 or higher, the vehicle 1 is automatically started and stopped in a state where the driver of the vehicle 1 is not obliged to monitor the surroundings. Note that the autonomous driving level in the present specification is based on the definition of SAE (Society of Automotive Engineers) J3016.

When the vehicle 1 is an autonomous vehicle, there is a possibility that the driver of the rear vehicle located behind the vehicle 1 may distrust the behavior of the vehicle 1. Therefore, in the present embodiment, ECU 20 functions as an information notification device that notifies the rear vehicle of the visual information, and the information regarding the behavior of the vehicle 1 is notified to the rear vehicle.

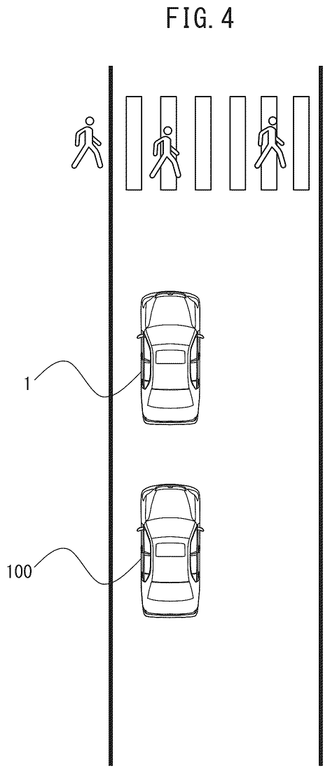

FIG. 3 is a functional block view of a processor 23 of ECU 20. In the present embodiment, the processor 23 includes a vehicle control unit 24 and a notification control unit 25. The vehicle control unit 24 and the notification control unit 25 are functional modules realized by ECU 20 processor 23 executing programs stored in the memory 22 of ECU 20. Note that each of these functional modules may be realized by a dedicated arithmetic circuit provided in the processor 23.

The vehicle control unit 24 controls the behavior of the vehicle 1 using the actuator 7 on the basis of the peripheral information detected by the peripheral information detection device 2. For example, when the predetermined condition is satisfied, the vehicle control unit 24 stops the vehicle 1 in order to allow others (for example, a pedestrian, a bicycle, a surrounding vehicle, or the like) to pass. The predetermined condition is, for example, that a pedestrian or a bicycle is trying to cross a crosswalk.

The notification control unit 25 controls the first display 9 to control the notification by the first display 9, and controls the second display 10 to control the notification by the second display 10. Normally, it is difficult to grasp a situation in front of the vehicle 1 from the rear vehicle located behind the vehicle 1. Therefore, the notification control unit 25 notifies the rear vehicle of the information via the first display 9. For example, when the vehicle 1 is stopped, the notification control unit 25 notifies the rear vehicle of the reason why the vehicle 1 is stopped via the first display 9.

In particular, in a case where the vehicle 1 is stopped in order to allow others to pass, there is a possibility that the rear vehicle cannot correctly grasp the intention of the vehicle 1. FIG. 4 is a view showing an example of a situation in which the vehicle 1 grants right of way to others. In the example of FIG. 4, the vehicle 1 is giving way to a pedestrian crossing the crosswalk, and the rear vehicle 100 behind the vehicle 1 is also stopped as the vehicle 1 is stopped. In such a situation, the driver of the rear vehicle 100 cannot visually recognize the pedestrian in front of the vehicle 1, and the rear vehicle 100 may attempt to pass the vehicle 1. Therefore, in the present embodiment, the notification control unit 25 notifies the rear vehicle 100 that the vehicle 1 is giving way to others via the first display 9 in a stop state in which the vehicle 1 is stopped in order to give way to others (hereinafter, simply referred to as a “stop state”). This makes it possible to accurately convey the intention of the vehicle 1 to the rear vehicle 100 when the vehicle 1 is giving way to others.

Further, even if the rear vehicle 100 is notified of the reason for stopping the vehicle 1, there is a possibility that the rear vehicle 100 will attempt reckless passing of the vehicle 1. Therefore, when passing of the vehicle 1 by the rear vehicle 100 is detected in the stop state, the notification control unit 25 notifies others in front of the vehicle 1 of a warning via the second display 10. This makes it possible to alert others and reduce the risk of others colliding with the rear vehicle 100.

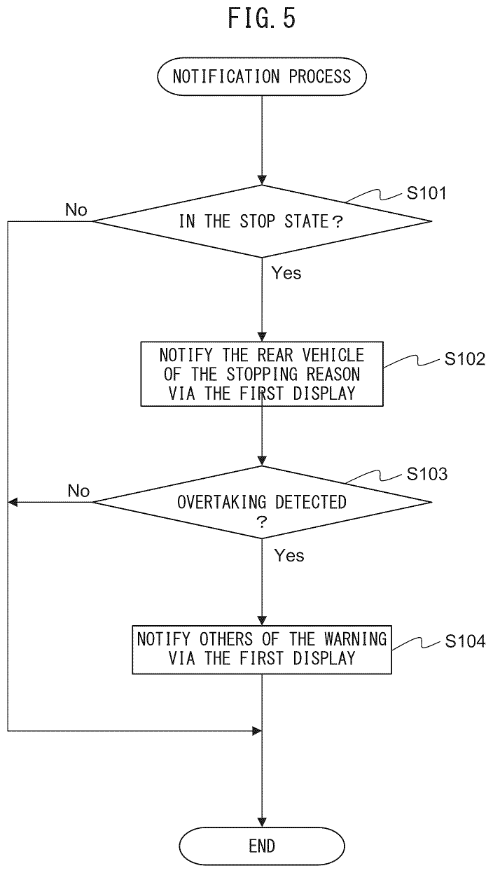

Hereinafter, a processing flow of the above-described control will be described with reference to FIG. 5. FIG. 5 is a flowchart showing the control routine of the notification process according to the present embodiment. The control routine is repeatedly executed by the processor 23 of ECU 20 at predetermined execution intervals.

First, at step S101, the notification control unit 25 of the processor 23 determines whether or not the vehicle 1 is in the stop state. When it is determined that the vehicle 1 is not in the stop state, the control routine ends. On the other hand, if it is determined that the vehicle 1 is in the stop state, the control routine proceeds to step S102.

At step S102, the notification control unit 25 notifies the rear vehicle 100 of the reason for stopping the vehicle via the first display 9. That is, the notification control unit 25 notifies the rear vehicle 100 that the vehicle 1 is giving way to others via the first display 9.

Note that the notification control unit 25 may present a notification prohibiting the passing of the vehicle 1 to the rear vehicle 100 via the first display 9 in the stop state. As a result, it is possible to further prevent the rear vehicle 100 from attempting to pass the vehicle 1.

In addition, the notification control unit 25 may notify the rear vehicle 100 of the time until the vehicle 1 starts via the first display 9 in the stop state. As a result, the driver of the rear vehicle 100 can grasp the start timing of the vehicle 1, and the driver of the rear vehicle 100 can feel safe.

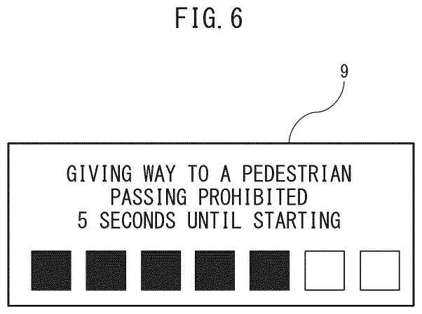

FIG. 6 is a view showing an example of information displayed on the first display 9 for the rear vehicle 100. In the example of FIG. 6, text messages and images are displayed on the first display 9 as information to be notified to the rear vehicle 100. Specifically, the rear vehicle 100 is notified that the vehicle 1 is giving way to others (in this example, the pedestrian) by the text message “giving way to a pedestrian”, and the rear vehicle 100 is notified that the passing of the vehicle 1 is prohibited by the text message “passing prohibited”. Further, the time until the vehicle 1 starts is notified to the rear vehicle 100 by the text message “5 seconds until starting” and an image indicating the remaining time until starting.

Note that the first display 9 may include a side display (not shown) arranged on a side portion of the vehicle 1 (for example, a side door of the vehicle 1), and the notification control unit 25 may present a notification to a two-wheeled vehicle behind, such as a motorcycle, via the side display. Such notification is, for example, a notification (e.g., a text message “passing of a two-wheeled vehicle prohibited”) to stop the two-wheeled vehicle from passing. The side display could be arranged on the left side of a vehicle in a country where traffic travels on the left-hand side of the road, and on the right side of a vehicle in a country where traffic travels on the right-hand side of the road.

Next, at step S103, the notification control unit 25 determines whether or not the passing of the vehicle 1 by the rear vehicle 100 has been detected. For example, the notification control unit 25 detects the passing of the vehicle 1 by the rear vehicle 100 based on peripheral information detected by the peripheral information detection device 2. If it is determined that passing has not been detected, the present control routine ends. On the other hand, if it is determined that passing has been detected, the control routine proceeds to step S104.

At step S104, the notification control unit 25 notifies, via the second display 10, others located in front of the vehicle 1, that is, a person who has been given way by the vehicle 1, of a warning. For example, the notification control unit 25 notifies others of the warning by displaying at least one of a text message and an image warning of the danger on the second display 10. In addition to the warning using the second display 10, the notification control unit 25 may notify others with an audible warning (for example, a horn sound). After step S104, the control routine ends.

Note that the notification control unit 25 may notify the rear vehicle 100 that the vehicle 1 is giving way to others by displaying images generated by the front camera 2a provided in the vehicle 1 on the first display 9 in the stop state. By displaying the camera image on the first display 9, the driver of the rear vehicle 100 can grasp the situation in front of the vehicle 1 from the viewpoint of the vehicle 1. Note that, in this case, information such as a notification not to pass the vehicle 1 and the time until the vehicle 1 starts may be superimposed on the image generated by the front camera 2a.

In addition, in the stop state, the notification control unit 25 notifies the rear vehicle 100 using the first display 9 when the driving mode of the rear vehicle 100 is manual driving or autonomous driving at level 2 or less, and does not need to notify the rear vehicle 100 using the first display 9 when the driving mode of the rear vehicle 100 is automatic driving at level 3 or more. As a result, it is possible to avoid presentation of visual information to the rear vehicle 100 even though the driver is not obliged to monitor the periphery, and it is possible to suppress power consumption of the first display 9. In this case, between the step S101 and the step S102, the notification control unit 25 determines whether or not the driving mode of the rear vehicle 100 is the autonomous driving at the level 3 or more, and when this determination is affirmative, the present control routine ends. In order to make this determination, the notification control unit 25 acquires, for example, the driving mode of the rear vehicle 100 via the inter-vehicle communication between the vehicle 1 and the rear vehicle 100. In a case where the driving mode of the rear vehicle 100 is autonomous driving at the level 3 or more in the stop state, the notification control unit 25 may notify the rear vehicle 100 that the vehicle 1 is giving way to others via the inter-vehicle communication.

In addition, in the stop state, the notification control unit 25 notifies the rear vehicle 100 using the first display 9 when the signal in front of the vehicle 1 is green, and does not need to notify the rear vehicle 100 using the first display 9 when the signal in front of the vehicle 1 is red. As a result, it is possible to avoid presenting visual information to the rear vehicle 100 that is extremely unlikely to attempt passing, and it is possible to suppress power consumption of the first display 9. In this case, between the step S101 and the step S102, the notification control unit 25 determines whether or not the signal in front of the vehicle 1 is red, and if this determination is affirmative, the present control routine ends. For example, the notification control unit 25 determines the color of the signal in front of the vehicle 1 based on the peripheral information detected by the peripheral information detection device 2.

Above, embodiments of the present disclosure were explained, but the above embodiments only show some of the examples of application of the present disclosure and are not intended to limit the technical scope of the present disclosure to the specific constitutions of the above embodiments. For example, the notification control unit 25 may present a notification of giving right of way to others (for example, at least one of a text message and an image indicating the right of way permission) via the second display 10 when the vehicle 1 gives way to others.

In addition, in a case where a plurality of rear vehicles are stopped behind the vehicle 1 in the stop state, the information may be sequentially transmitted from the first rear vehicle to the last rear vehicle. In this case, when the information is notified from the vehicle in front to the vehicle behind, the rear vehicle notifies another rear vehicle further behind of the same information. At this time, when the rear vehicle has a display device such as the first display 9, the information is notified via the display device, and when the rear vehicle does not have a display device such as the first display 9, the information is notified via the inter-vehicle communication.

In addition, a display control device including a processor and a memory may be attached to the vehicle 1 together with the first display 9 and the second display 10, and the display control device may function as an information notification device to execute the above-described information notification method. In addition, a server or a control center capable of communicating with the vehicle 1 via wide area communication such as a communication network may function as an information notification device and execute the information notification method as described above. Further, the second display 10 may be omitted.

In addition, a computer program that causes a computer to realize the functions of the respective units included in the processor 23 of ECU 20 may be provided in a form stored in a computer-readable recording medium. The computer-readable recording medium is, for example, a magnetic recording medium, an optical recording medium, or a semiconductor memory.

1. An information notification device configured to notify visual information to a rear vehicle located behind a host vehicle that automatically starts and stops, wherein
the information notification device comprises a notification control unit configured to notify the rear vehicle that the host vehicle is giving right of way to others via a first display provided in the host vehicle so as to be visually recognized from the rear vehicle in a stop state in which the host vehicle is stopped in order to give right of way to others.

2. The information notification device according to claim 1, wherein
the notification control unit is configured to notify the rear vehicle of a time until the vehicle starts, via the first display, in the stop state.

3. The information notification device according to claim 1, wherein
the notification control unit is configured to notify the others of a warning via a second display provided in the host vehicle so as to be visually recognized from the front of the host vehicle when the passing of the host vehicle by the rear vehicle is detected in the stop state.

4. The information notification device according to claim 1, wherein
the notification control unit is configured to notify the rear vehicle that the host vehicle is giving right of way to others by displaying an image generated by a front camera provided in the host vehicle on the first display in the stop state.

5. An information notification method executed by a computer, wherein
the information notification method includes notifying a rear vehicle that a host vehicle is giving right of way to others via a first display provided in the host vehicle so as to be visually recognized from the rear vehicle in a stop state in which the host vehicle is stopped in order to give right of way to the others.
